(19) United States
(12) Patent Application Publication
(10) Pub. No.: US 2010/0284562 A1
(43) Pub. Date: Nov. 11, 2010

(54) DIAPHRAGM AND SPEAKER INCLUDING SAME

(75) Inventors: Kazuyuki Kosuda, Neyagawa-shi (JP); Yoshiko Koda, Daito-shi (JP)

Correspondence Address: SCHWEGMAN, LUNDBERG & WOESSNER, P.A., P.O. BOX 2938, MINNEAPOLIS, MN, 55402, US

(73) Assignee: Sanyo Electric Co., Ltd., Osaka (JP)

(21) Appl. No.: 12/678,438

(22) PCT Filed: Sep. 17, 2009
(86) PCT No.: PCT/JP2008/066760

§ 371 Date: Jul. 12, 2010

(30) Foreign Application Priority Data
Sep. 21, 2007 (JP) 2007-246073

(51) Int. Cl. H04R 1/00

(52) U.S. Cl. 381/423

(57) ABSTRACT

[Problems] To provide a diaphragm enabling prevention of an unnecessary depression at the end of a diaphragm piece in a major-axis direction and reduction of the distortion of the sound produced by a speaker and a speaker including the same.

[Means for Solving Problems] A diaphragm (4) has a noncircular shape with a major axis α and a minor axis β different from each other and includes a diaphragm piece (4a). When the length γ of the diaphragm piece (4a) in a major-axis direction (X) is denoted by 2a, the length δ of the diaphragm piece (4a) in a minor-axis direction Y is denoted by 2b, the length s from the center O of the diaphragm (4) in the major-axis direction X to the periphery (42a) of the diaphragm piece (4a) is denoted by x, and the length t from the center O of the diaphragm (4) in the minor-direction Y to the periphery (42a) of the diaphragm piece (4a) is denoted by y, the shape of the periphery (42a) of the diaphragm piece (4a) satisfies the following formula 1.

### TECHNICAL FIELD

The present invention relates to a non-circular diaphragm and a speaker including the same.

### BACKGROUND ART

Generally, an electronic device such as a mobile phone includes a speaker, which is an acoustic device. The speaker includes a diaphragm on which a coil is arranged and a magnet, which faces toward the diaphragm spaced by a predetermined interval and which generates a magnetic field near the coil. When electric current flows through the coil, the diaphragm vibrates in a direction orthogonal to both the direction of the electric current and the direction of the magnetic field.

Further, since electronic devices such as mobile phones have become smaller in size, the space available for mounting components in an electronic device has decreased. A known speaker includes a non-circular diaphragm, which has a major axis and a minor axis that are different from each other, so that it may be mounted in the limited component mounting space (e.g., elongated space). The non-circular diaphragm, the major axis and the minor axis of which are different from each other, may include a diaphragm segment 104a having a partially-arched, oblong shape as shown in FIG. 5 or an elliptical shape as shown in FIG. 6 (for example, refer to patent publication 1).

Generally, in compact electronic devices such as mobile phones, a diaphragm is molded from a thin film material having a predetermined strength such as engineering plastic (for example, refer to patent publication 2).

### Patent Publication 1: Japanese Laid-Open Patent Publication No. 2005-184588

### Patent Publication 2: Japanese Laid-Open Patent Publication No. 2004-312085

### DISCLOSURE OF THE INVENTION

### Problems that are to be Solved by the Invention

However, in the non-circular diaphragm 104, of which major axis α and minor axis β are different from each other, as the ratio of the major axis α relative to the minor axis β (major axis α/minor axis β) increases, formation of a depression H tends to occur in the diaphragm segment 104a at an end region in the major axis direction X. This may easily distort the sound produced by the speaker.

More specifically, for example, residual stress generated when molding the diaphragm 104 from a thin film material may form an unnecessary depression H in the diaphragm segment 104a at an end region 104c in the major axis direction X as shown in FIG. 7. The same kind of depression H may also be formed by the stress generated when the diaphragm 104 vibrates. In a speaker including the diaphragm 104 having such a depression H, the interval between the diaphragm 104 and a magnet (not shown), which faces toward the diaphragm 104, may become uneven. This may hinder proper vibration of the diaphragm 104. As a result, there is a tendency of distortion components in the sound produced by the speaker easily increasing near the minimum resonance frequency at which the vibration amplitude of the diaphragm 104 increases.

Accordingly, it is an object of the present invention to provide a diaphragm and a speaker including the diaphragm that prevents an unnecessary depression from being formed in a diaphragm segment at an end region in the major axis direction to reduce the distortion components in the sound produced by the speaker.

### Means for Solving the Problem

The invention recited in claim 1 is a diaphragm, which is non-circular and has a major axis and a minor axis that are different from each other, including a diaphragm segment. When the diaphragm segment has a length in a major axis direction represented by 2a, the diaphragm segment has a length in a minor axis direction represented by 2b, a length from a center of the diaphragm to a boundary of the diaphragm segment in the major axis direction is represented by x, and a length from the center of the diaphragm to the boundary of the diaphragm segment in the minor axis direction is represented by y, the boundary of the diaphragm segment is shaped to satisfy the following equation 1:

$$\frac{{x}^{3}}{{a}^{3}} + \frac{{y}^{3}}{{b}^{3}} = 1 \qquad ( 1 )$$

In this structure, when the diaphragm segment has a length in the major axis direction represented by 2a, the diaphragm segment has a length in the minor axis direction represented by 2b, the length from a center of the diaphragm to a boundary of the diaphragm segment in the major axis direction is represented by x, and the length from the center of the diaphragm to the boundary of the diaphragm segment in the minor axis direction is represented by y, the shape of the boundary of the diaphragm segment satisfies equation 1. Thus, the curved shape of the boundary of the diaphragm segment at the end region of the diaphragm segment in the major axis direction is flatter than the prior art (i.e., the curvature is smaller). Accordingly, the residual stress generated when the diaphragm is molded and the stress generated when the diaphragm vibrates are less concentrated at the end region of the diaphragm segment in the major axis direction. This prevents the formation of unnecessary depressions in the end region of the diaphragm segment in the major axis direction. As a result, the speaker including the diaphragm reduces distortion components in the sound produced by the speaker.

The invention recited in claim 2 is a speaker including the diaphragm according to claim 1.

This structure obtains the same advantages as the invention recited in claim 1.

### EFFECTS OF THE INVENTION

The prevent invention prevents the formation of unnecessary depressions at the end region of the diaphragm segment in the major axis direction and reduces distortion components in the sound produced by the speaker.

### BEST MODE FOR CARRYING OUT THE INVENTION

An embodiment of the present invention will now be discussed with reference to the drawings. The arrow Q in the drawings indicates the vibration direction of a diaphragm. Further, the arrow X indicates the major axis direction that is the longer direction of the diaphragm, and the arrow Y indicates the minor axis direction that is the shorter direction of the diaphragm.

Referring to FIGS. 1 and 2, a speaker of the present invention includes an elongated box-shaped frame F. Two outer magnets 2, which extend in the major axis direction X and an inner magnet 3, which extends in the major axis direction X, are arranged in the frame F on a bottom plate 1, which is formed from a ferromagnetic. The outer magnets 2 each include an upper portion 21 and a lower portion 22, which are respectively an S pole and an N pole. The inner magnet 3 includes an upper portion 31 and a lower portion 32, which are respectively an N pole and an S pole. Accordingly, the inner magnet 3 is arranged between the outer magnets 2. This generates a magnetic flux loop with the outer magnets 2 and the inner magnet 3 in the directions of the arrows C in FIG. 2.

The frame F supports a diaphragm 4, which has a generally planar shape and is arranged above the outer magnets 2 and the inner magnet 3 spaced by a predetermined interval. As shown in FIG. 3, the diaphragm 4 includes a rim 41, which is fixed to the frame F, and a vibratable diaphragm segment 4a. The rim 41 and the diaphragm segment 4a are formed integrally. The diaphragm segment 4a includes a peripheral portion 42, which defines a peripheral diaphragm, and a coil mounting portion 43 and dome portion 44, which define a central diaphragm segment. The peripheral portion 42 encompasses the central diaphragm segment (i.e., the coil mounting portion 43 and the dome portion 44).

The rim 41 is formed to be planar so that it may be placed on a support surface 12, which is formed in an upper portion of the frame F to support the diaphragm 4. The peripheral portion 42 is formed to be convex in the vibration direction Q so as to support and allow vibration of the coil mounting portion 43 and the dome portion 44, which define the central diaphragm segment. The coil mounting portion 43 is formed to be planar so that a coil 5 may be mounted to its lower surface 43a. The dome portion 44 is formed to be convex in the vibration direction Q.

A flattened coil 5 formed from a conductive wire that is wound about an axis parallel to the vibration direction Q is fixed to the lower surface 43a of the coil mounting portion 43. Since the direction of a magnetic field near the coil 5 is the minor axis direction Y, when electric current flows through the coil 5, the diaphragm 4 may be vibrated in a direction (i.e., vibration direction Q) perpendicular to the direction of the electric current (major axis direction X) and the direction of the magnetic field (minor axis direction Y).

A cover 6 including sound holes 61 is arranged above the diaphragm 4. The cover 6 has an end portion 62, which holds the rim 41 of the diaphragm 4 in cooperation with the support surface 12 of the frame F.

The feature of the present embodiment is in that the diaphragm segment 4a has a boundary 42a forming a cubic curve as shown in FIG. 3. The feature of the present invention will now be described in detail. The major axis α, the minor axis β, and the lengths γ, δ, s, t, u, and v are shown using the same unit of length.

The diaphragm 4 of the present embodiment is a non-circular diaphragm 4 having a major axis α (i.e., the length of the diaphragm 4 in the major axis direction X) and a minor axis β (i.e., the length of the diaphragm 4 in the minor axis direction Y). The ratio of the major axis a relative to the minor axis β (major axis α/minor axis β) is, for example, 1.985. Further, the ratio of the length γ of the diaphragm segment 4a in the major axis direction X relative to the length δ of the diaphragm segment 4a is 2.18.

In the present embodiment, when the length γ of the diaphragm segment 4a in the major axis direction X is 2a and the length δ of the diaphragm segment 4a in the short axis direction Y is 2b, the boundary 42a of the diaphragm segment 4a is shaped to satisfy equation (1), which is shown below.

$$\frac{{x}^{3}}{{a}^{3}} + \frac{{y}^{3}}{{b}^{3}} = 1 \qquad ( 1 )$$

In equation (1), x represents the length s from the center O of the diaphragm 4 to the boundary 42a of the diaphragm segment 4a in the major axis direction X, and y represents the length t from the center O of the diaphragm 4 to the boundary 42a of the diaphragm segment 4a in the minor axis direction Y. Further, in equation (1), a represents a length that is half the length γ of the diaphragm segment 4a in the major axis direction X, and b represents a length that is half the length δ of the diaphragm segment 4a in the minor axis direction Y.

In contrast with a diaphragm segment of which boundary is partially arched, the diaphragm 4 of the present embodiment prevents its center of gravity from moving away from the center O of the diaphragm 4 and thereby decreases distortion components in the sound produced by the speaker. That is, when the boundary of a diaphragm segment is partially arched, the position of the center of the arch moves the center of gravity. Thus, when molding the diaphragm, if part of the periphery of the diaphragm cannot be formed to have the appropriate arched shape, the center of gravity of the diaphragm is deviated from the center of the diaphragm. In a speaker including such a diaphragm, the diaphragm vibrates inclined relative to the vibration direction. This easily increases distortion components in the sound produced by the speaker. In the diaphragm 4 of the present embodiment, as shown in FIG. 3, the boundary 42a of the diaphragm segment 4a is shaped so that equation (1) is satisfied throughout the entire boundary 42a of the diaphragm segment 4a. Thus, in contrast to when the boundary of the diaphragm segment is formed to be partially arched, the center of gravity of the diaphragm 4 is prevented from being deviated from the center O. As a result, in a speaker including the diaphragm 4, the diaphragm 4 is vibrated parallel to the vibration direction Q, and distortion components in the sound produced by the speaker are decreased.

Further, in the present embodiment, when the length of the rim 41 in the major axis direction X (i.e., major axis a) is 2c, and the length of the rim 41 in the minor axis direction Y (i.e., minor axis β) is 2d, a periphery 41a of the rim 41 is shaped to satisfy equation (2), which is shown below.

$$\frac{{z}^{3}}{{c}^{3}} + \frac{{w}^{3}}{{d}^{3}} = 1 \qquad ( 2 )$$

In equation (2), z represents the length u from the center O of the diaphragm 4 to the periphery 41a of the rim 41 in the major axis direction X, and w represents the length v from the center O of the diaphragm 4 to the periphery 41a of the rim 41 in the minor axis direction Y. Further, in equation (2), c represents a length that is half the length of the major axis α, and b represents a length that is half the length of the minor axis β.

The diaphragm 4 of the above-described embodiment has the advantages described below.

(1) The diaphragm 4 includes the non-circular diaphragm segment 4a of which the major axis α differs from the minor axis R. As described above, when the length γ is 2a, the length δ is 2b, the length s is x, and the length t is y, the boundary 42a of the diaphragm segment 4a is shaped to satisfy equation (1). Thus, as shown in FIG. 3, the curved shape of the boundary 42a of the diaphragm segment 4a at the end region 4c of the diaphragm segment 4a in the major axis direction X is flatter than the prior art (i.e., the curvature is smaller). Accordingly, the residual stress generated when the diaphragm 4 is molded and the stress generated when the diaphragm 4 vibrates are less concentrated at the end region 4c of the diaphragm segment 4a in the major axis direction X. This prevents the formation of unnecessary depressions in the end region 4c of the diaphragm segment 4a in the major axis direction X. In this case, the diaphragm 4 has a cross-sectional shape (the shape of the B-B cross-section taken in FIG. 3) that is in linear symmetry about an axis formed along a straight line, which is parallel to the vibration direction and extends through the center O of the diaphragm 4. As a result, the speaker including the diaphragm 4 reduces distortion components in the sound produced by the speaker.

(2) The diaphragm 4 further includes the rim 41. As described above, when the length of the rim 41 in the major axis direction X (i.e., major axis α) is 2c, the length of the rim 41 in the minor axis direction Y (i.e., minor axis β) is 2d, the length u is z, and the length v is w, the periphery 41a of the rim 41 is shaped to satisfy equation (2). Thus, the residual stress generated during molding of the diaphragm 4 is less concentrated at the end region of the rim 41 in the major axis direction X, and the same effects as advantage (1) are obtained.

Further, the speaker of the present embodiment includes the diaphragm 4. Thus, the speaker obviously has the above-described advantages (1) and (2).

In the above-described embodiment, the rim 41 and the diaphragm segment 4a are formed integrally. However, they do not have to be formed integrally. In the same manner, the peripheral portion 42, which defines the peripheral diaphragm segment, and the coil mounting portion 43 and the dome portion 44, which define the central diaphragm segment, may be formed to be either integral or not integral.

In the above-described embodiment, the audio device including the diaphragm is a speaker. However, the audio device may be a telephone receiver.

### BRIEF DESCRIPTION OF THE DRAWINGS

FIG. 1 is a perspective view showing a speaker according to one embodiment of the present invention;

FIG. 2 is a cross-sectional view of the speaker according to the embodiment of the present invention;

FIG. 3 is an upper view showing a diaphragm according to the embodiment of the present invention;

FIG. 4(a) is a cross-sectional view and FIG. 4(b) is a partially enlarged view showing the diaphragm according to the embodiment of the present invention;

FIG. 5 is an upper view showing a diaphragm of the prior art;

FIG. 6 is an upper view showing the diaphragm of the prior art; and

FIG. 7(a) is a cross-sectional view and FIG. 7(b) is a partially enlarged view showing the diaphragm of the prior art.

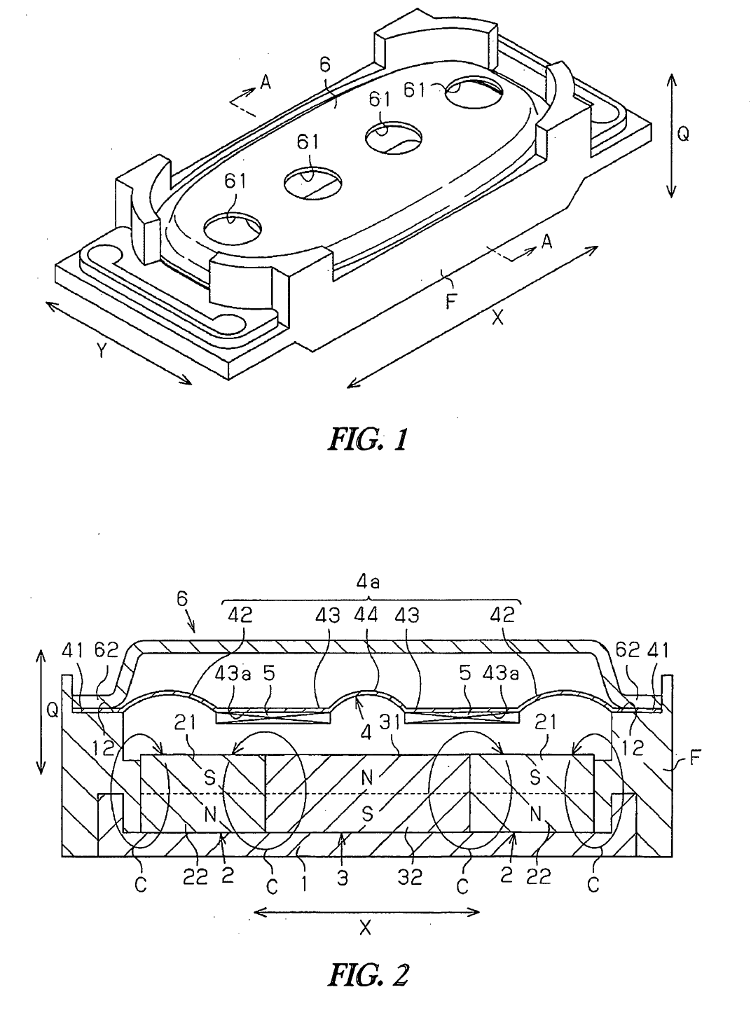

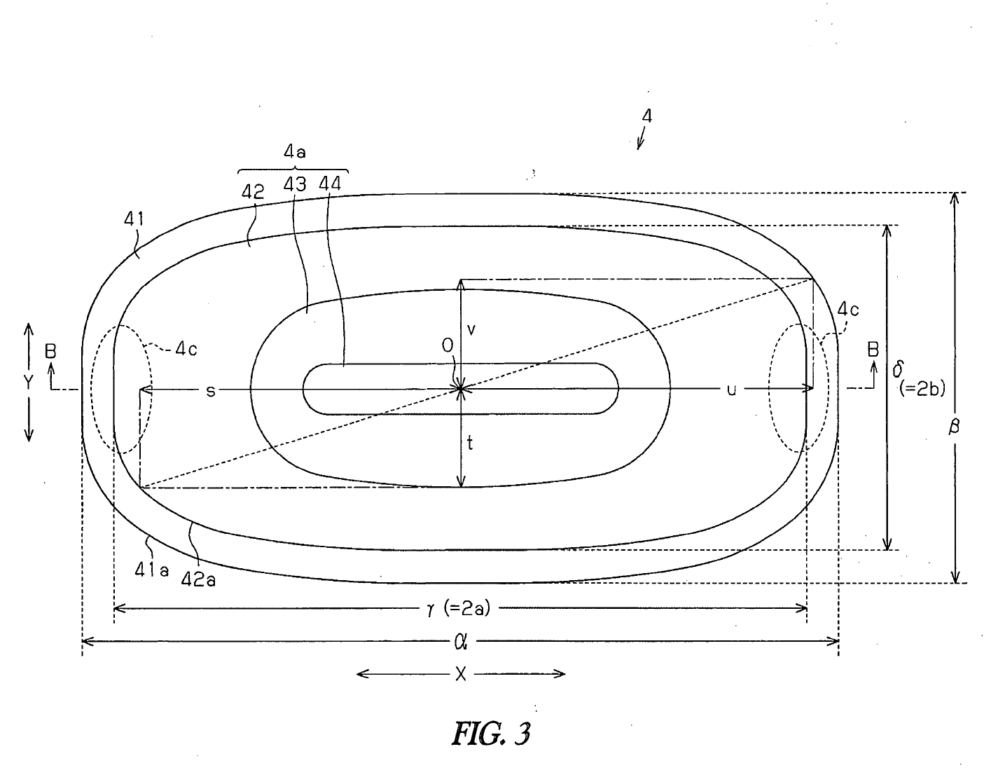

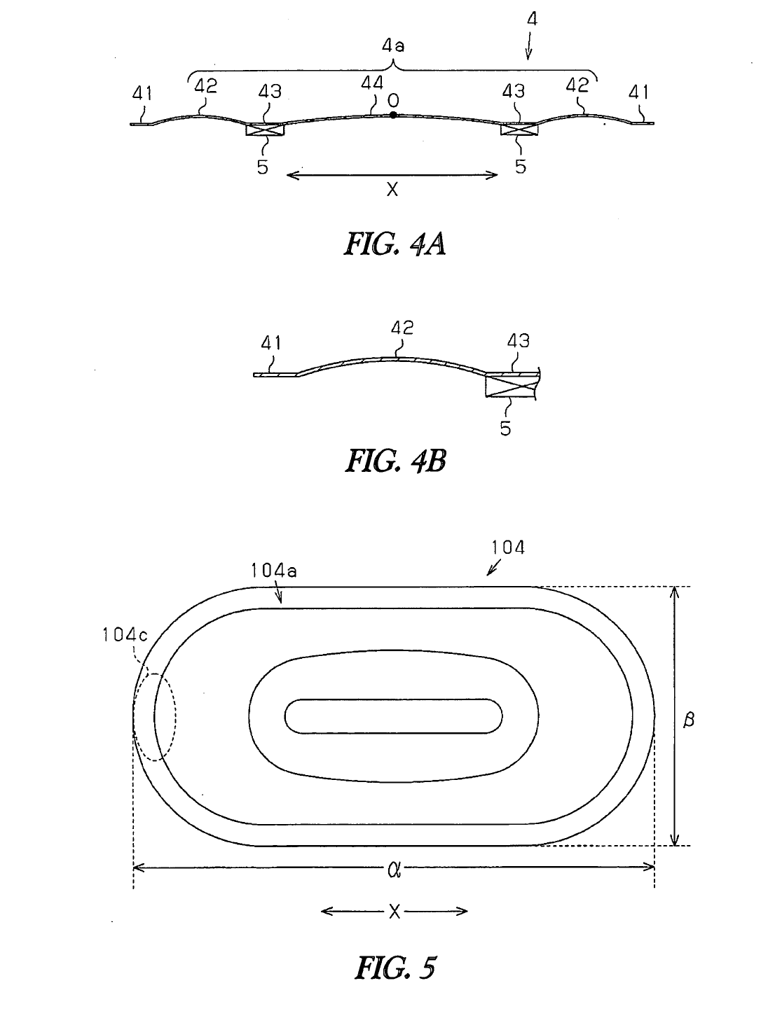

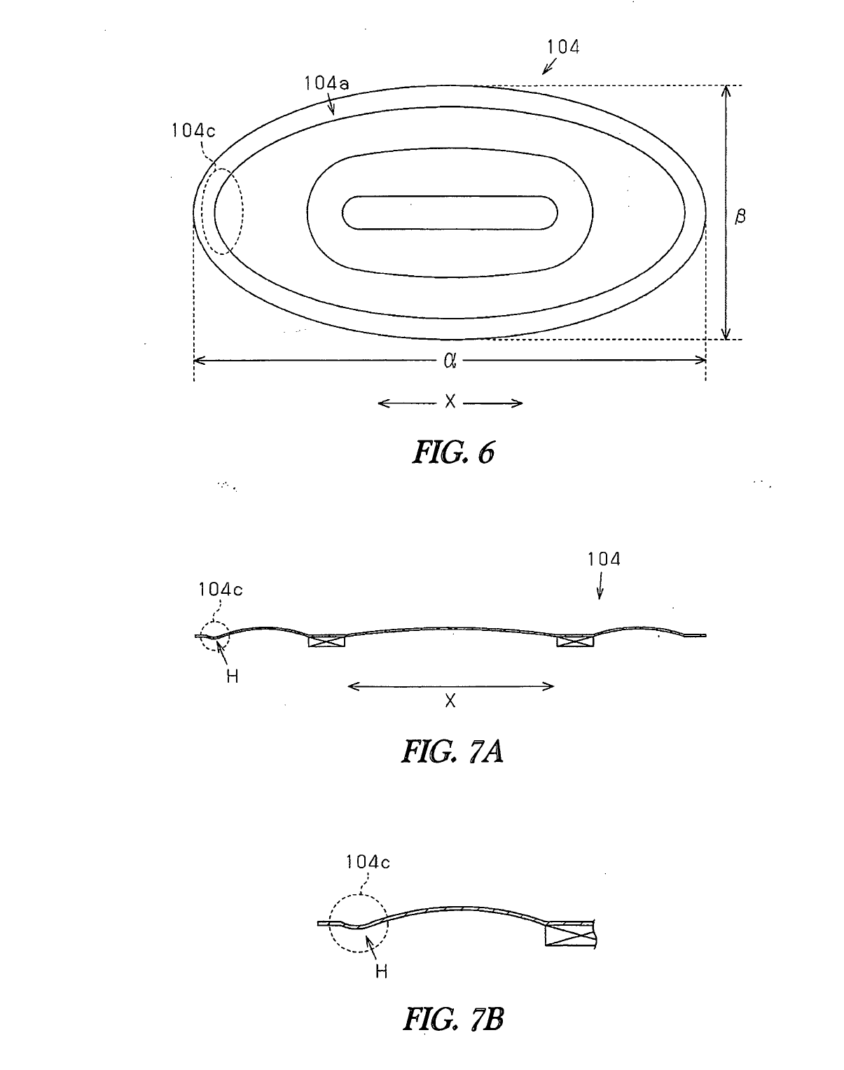

### DESCRIPTION OF THE REFERENCE CHARACTERS

α . . . major axis, β . . . minor axis, γ, δ, s, t, u, v . . . lengths, O . . . center, X . . . major axis direction, Y . . . minor axis direction, F . . . frame, 1 . . . bottom plate, 2 . . . outer magnets, 3 . . . inner magnet, 4 . . . diaphragm, 4a . . . diaphragm segment, 4c . . . end region, 5 . . . coil, 6 . . . cover, 42 . . . peripheral portion (peripheral diaphragm segment), 42a . . . boundary.

1. A diaphragm, which is non-circular and has a major axis and a minor axis that are different from each other, including a diaphragm segment including a peripheral diaphragm that is formed to be convex in a vibration direction, the diaphragm being characterized in that:
when the diaphragm segment has a length in a major axis direction represented by 2a, the diaphragm segment has a length in a minor axis direction represented by 2b, a length from a center of the diaphragm to a boundary of the diaphragm segment in the major axis direction is represented by x, and a length from the center of the diaphragm to the boundary of the diaphragm segment in the minor axis direction is represented by y, the boundary of the diaphragm segment defined by the peripheral diaphragm is shaped to satisfy the following equation 1:
$$\frac{{x}^{3}}{{a}^{3}} + \frac{{y}^{3}}{{b}^{3}} = 1 \qquad ( 1 )$$

2. A speaker comprising the diaphragm according to claim 1.

3. The diaphragm according to claim 1, wherein the diaphragm segment further includes a central diaphragm segment vibratably supported by the peripheral diaphragm, the central diaphragm segment including a dome portion formed to be convex in the vibration direction and a coil mounting portion formed to be planar and arranged between the dome portion and the peripheral diaphragm.
